(19) United States
(12) Patent Application Publication
(10) Pub. No.: US 2025/0370486 A1
(43) Pub. Date: Dec. 4, 2025

(54) CONTROL SYSTEM, CONTROL DEVICE, AND CONTROL METHOD

(71) Applicant: MITSUBISHI HEAVY INDUSTRIES, LTD., Tokyo (JP)

(72) Inventor: Hiromitsu MORI, Tokyo (JP)

(21) Appl. No.: 19/217,127

(22) Filed: May 23, 2025

(30) Foreign Application Priority Data
May 29, 2024 (JP) 2024-087174

(51) Int. Cl. G05D 7/06

(52) U.S. Cl. CPC G05D 7/0635

(57) ABSTRACT

A control system includes: a first control device; a second control device; and a communication unit configured to input and output a predetermined signal between the first control device and the second control device, in which the second control device includes: a delay unit configured to output a plurality of output signals, each of which is a signal obtained by delaying an input signal by a plurality of different delay times; and an output unit configured to output the plurality of output signals of the delay unit to the communication unit, and the first control device includes: an input unit configured to be input the plurality of output signals from the communication unit at a time interval longer than the shortest delay time; and a storage unit configured to store the plurality of input output signals.

### BACKGROUND OF THE INVENTION

### Technical Field

The present disclosure relates to a control system, a control device, and a control method. Priority is claimed on Japanese Patent Application No. 2024-087174, filed May 29, 2024, the content of which is incorporated herein by reference.

### Background Art

Patent Literature 1 describes, as background art (FIG. 6 of Patent Literature 1, and the like), a configuration in which oversampling is performed by supplying, to each of clock terminals of a plurality of D-type flip-flops, a plurality of clocks generated by inputting a sampling clock obtained by multiplying a system clock to a series circuit in which a plurality of delay elements having a predetermined delay time are connected in series. According to this configuration, it is possible to obtain a time resolution higher than a cycle obtained by multiplying the system clock, for example.

### CITATION LIST

### Patent Literature

[Patent Literature 1] Japanese Unexamined Patent Application, First Publication No. 2009-264827

### SUMMARY OF INVENTION

In a distributed control system that constitutes a system including a higher-level control device, one or more lower-level control devices, and a communication unit between the higher-level control device and the lower-level control devices, there is a need for the higher-level control device to acquire data generated in the lower-level control devices at a cycle shorter than a data input cycle from the communication unit in the higher-level control device. In this case, because of a restriction imposed by the communication unit, for example, even though a configuration for taking in data by oversampling as described in Patent Literature 1 is provided in the higher-level control device, it is not effective.

The present disclosure has been made in consideration of the above-mentioned circumstances, and an object of the present disclosure is to provide a control system, a control device, and a control method that can appropriately input a signal generated by a lower-level control device from a communication unit in a higher-level control device at a cycle shorter than an input cycle from the communication unit in the higher-level control device.

In order to solve the above-described problems, according to the present disclosure, there is provided a control system including: a first control device; a second control device; and a communication unit configured to input and output a predetermined signal between the first control device and the second control device, in which the second control device includes: a delay unit configured to output a plurality of output signals, each of which is a signal obtained by delaying an input signal by a plurality of different delay times; and an output unit configured to output the plurality of output signals of the delay unit to the communication unit, and the first control device includes: an input unit configured to be input the plurality of output signals from the communication unit at a time interval longer than the shortest delay time; and a storage unit configured to store the plurality of input output signals.

According to the present disclosure, there is provided a control method for a control system including a first control device, a second control device, and a communication unit configured to input and output a predetermined signal between the first control device and the second control device, in which the second control device includes: a delay unit configured to output a plurality of output signals, each of which is a signal obtained by delaying an input signal by a plurality of different delay times; and an output unit configured to output the plurality of output signals of the delay unit to the communication unit, the control method including, in the first control device: a step of inputting the plurality of output signals from the communication unit at a time interval longer than the shortest delay time; and a step of storing the plurality of input output signals.

With the control system, the control device, and the control method according to the present disclosure, a signal generated by a second control device can be appropriately input from a communication unit in a first control device at a cycle shorter than an input cycle from the communication unit in the first control device.

### BRIEF DESCRIPTION OF DRAWINGS

FIG. 1 is a block diagram showing a configuration example of a control system according to an embodiment of the present disclosure.

FIG. 2A is a block diagram showing a configuration example of a recording data processing unit and the like according to the embodiment of the present disclosure.

FIG. 2B is a block diagram showing another configuration example of a recording data processing unit and the like according to the embodiment of the present disclosure.

FIG. 3 is a flowchart showing an operation example of a low-speed calculation control device according to the embodiment of the present disclosure.

FIG. 4 is a timing chart showing an operation example of the control system according to the embodiment of the present disclosure.

FIG. 5 is a schematic block diagram showing a configuration of a computer according to the embodiment of the present disclosure.

### DESCRIPTION OF EMBODIMENTS

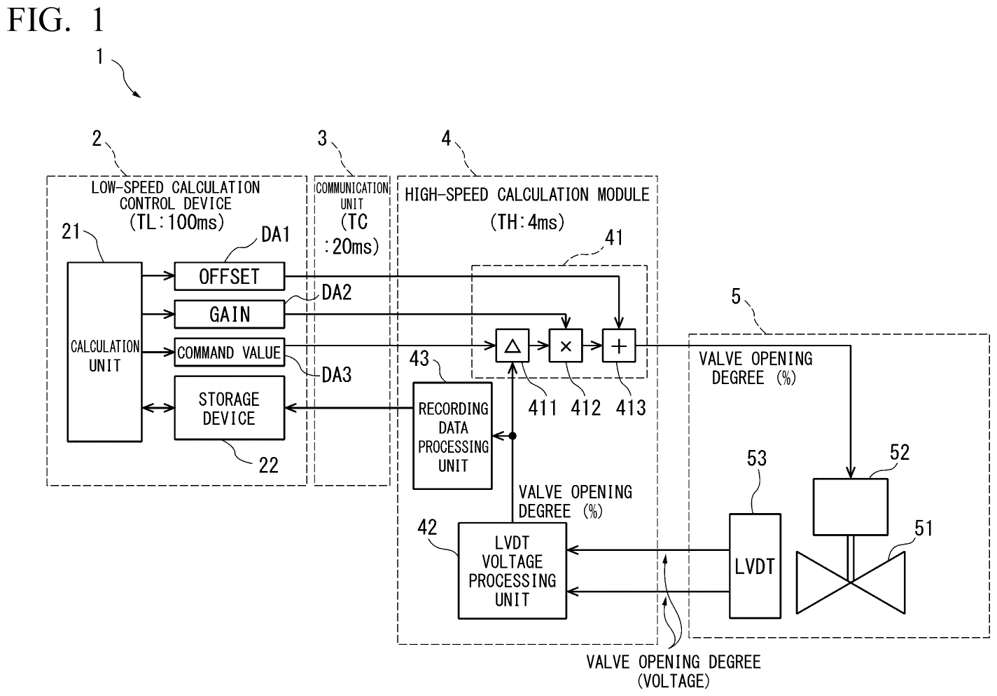

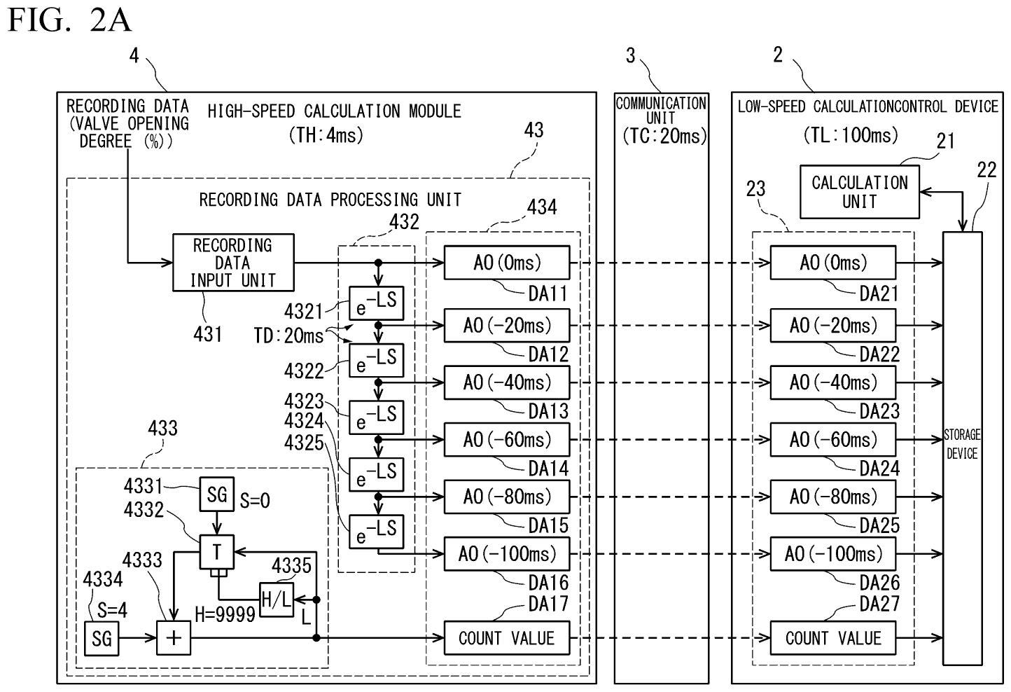

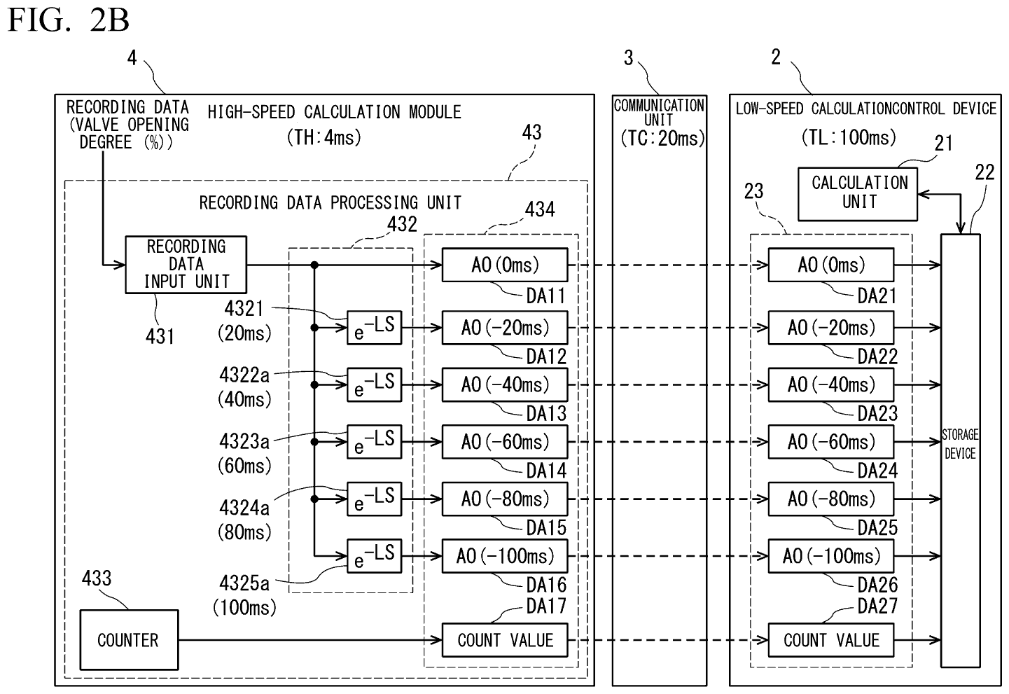

A control system and a control method according to an embodiment of the present disclosure will be described below with reference to FIGS. 1 to 4. In each drawing, the same reference numerals are used for the same or corresponding components, and the description thereof will be omitted as appropriate. FIG. 1 is a block diagram showing a configuration example of a control system according to an embodiment of the present disclosure. FIG. 2A is a block diagram showing a configuration example of a recording data processing unit and the like according to the embodiment of the present disclosure. FIG. 2B is a block diagram showing another configuration example of a recording data processing unit and the like according to the embodiment of the present disclosure.

As shown in FIG. 1, a control system 1 includes a low-speed calculation control device 2, a communication unit 3, a high-speed calculation module 4, and a field equipment 5. The field equipment 5 includes a control valve 51, which is a servo valve that uses high-pressure electro hydraulic (EH) oil, a servo valve actuator 52 that drives the control valve 51, and a linear variable differential transformer (LVDT) 53, which is a sensor that detects mechanical linear motion and converts the mechanical linear motion into a voltage or the like for output. The control valve 51 is used, for example, as a fuel control valve in a gas turbine, a steam control valve in a steam turbine, and the like. In addition, the LVDT 53 outputs a signal (a voltage signal in the present embodiment) indicating a valve opening degree of the control valve 51. The servo valve actuator 52 adjusts the valve opening degree based on a control signal indicating the valve opening degree (%) output from the high-speed calculation module 4. In the present embodiment, a digital signal (or a signal, an input signal, an output signal, a control signal, and the like) that is not an analog signal is considered to have the same meaning as data.

The communication unit 3 includes a communication cable connecting the low-speed calculation control device 2 and the high-speed calculation module 4, a communication interface partly or entirely included in the low-speed calculation control device 2 and the high-speed calculation module 4, and the like, and transmits (transmits and receives) a predetermined signal between the low-speed calculation control device 2 and the high-speed calculation module 4, for example, at a communication cycle TC (which in the present embodiment is set to 20 milliseconds (ms) as an example). In the present embodiment, the low-speed calculation control device 2 transmitting a signal to the high-speed calculation module 4 via the communication unit 3 and the high-speed calculation module 4 receiving a signal from the low-speed calculation control device 2 via the communication unit 3 are also referred to as the low-speed calculation control device 2 outputting a signal to the communication unit 3 and the high-speed calculation module 4 being input a signal from the communication unit 3. In addition, the high-speed calculation module 4 transmitting a signal to the low-speed calculation control device 2 via the communication unit 3 and the low-speed calculation control device 2 receiving a signal from the high-speed calculation module 4 via the communication unit 3 are also referred to as the high-speed calculation module 4 outputting a signal to the communication unit 3 and the low-speed calculation control device 2 being input a signal from the communication unit 3. The communication unit 3 can be configured using, for example, a local area network (LAN).

The high-speed calculation module 4 performs feedback control of the control valve 51 according to an instruction from the low-speed calculation control device 2, with a basic control cycle being a high-speed cycle TH (which is set to 4 ms, for example, in the present embodiment). The high-speed calculation module 4 includes, for example, a microcontroller, a field programmable gate array (FPGA), an analog/digital (A/D) converter, a D/A converter, an amplifier circuit, a photocoupler, a power supply circuit, and the like, and includes functional blocks configured using these components, such as an adjustment unit 41, an LVDT voltage processing unit 42, and a recording data processing unit 43.

The LVDT voltage processing unit 42 converts an analog voltage signal indicating the measurement value of the valve opening degree output by the LVDT 53 into a digital signal indicating the valve opening degree in percentage (%) and outputs the digital signal. The adjustment unit 41 outputs a control signal indicating the valve opening degree (%) based on an offset (OFFSET) DA1, a gain (GAIN) DA2 and a command value (target value) DA3 of the valve opening degree received from the low-speed calculation control device 2 via the communication unit 3, and the valve opening degree (%) output by the LVDT voltage processing unit 42. In the example shown in FIG. 1, the adjustment unit 41 includes a subtractor 411, a multiplier 412, and an adder 413. The subtractor 411 outputs the result (deviation) of subtracting the valve opening degree (%) output by the LVDT voltage processing unit 42 from the command value DA3. The multiplier 412 outputs a value obtained by multiplying the deviation output by the subtractor 411 by the gain DA2. The adder 413 adds the offset DA1 to the value output by the multiplier 412, and outputs the added value as a control signal (valve opening degree (%)). In this case, the adjustment unit 41 performs feedback control of the valve opening degree by proportional control (P control) so that the valve opening degree coincides with the command value. The output cycle of the signal by the LVDT voltage processing unit 42 and the calculation cycle (output cycle of the signal and the like) in the adjustment unit 41 are the high-speed cycle TH.

The recording data processing unit 43 executes signal processing to transmit recording data to the low-speed calculation control device 2 via the communication unit 3, using the signal indicating the valve opening degree (%) output by the LVDT voltage processing unit 42 as the recording data (data to be recorded by the low-speed calculation control device 2) (details will be described later).

The low-speed calculation control device 2 includes, for example, a central processing unit (CPU), a memory, an input/output interface, a communication interface, and the like, and controls one or more high-speed calculation modules, such as the high-speed calculation module 4, based on a control signal received from a higher-level control device (not shown), with a basic control cycle being a low-speed cycle TL (which in the present embodiment is set to 100 ms as an example). The low-speed cycle TL and the high-speed cycle TH are affected by, for example, the occurrence of a signal such as an interrupt signal that takes priority over a signal that controls the control cycle, and the cycles are not necessarily constant. The low-speed calculation control device 2 includes a calculation unit 21 and a storage device 22. The calculation unit 21 generates the offset DA1, the gain DA2 and the command value DA3 based on a control signal received from a higher-level control device (not shown) and outputs the offset DA1, the gain DA2 and the command value DA3 to the high-speed calculation module 4, and also reconstructs the recording data stored in the storage device 22 into time-series data. The storage device 22 stores the recording data received from the high-speed calculation module 4 and stores the reconstructed recording data.

In the present embodiment, the low-speed calculation control device 2 is a configuration example of a “first control device” according to the present disclosure. The high-speed calculation module 4 is a configuration example of a “second control device” according to the present disclosure.

Next, a configuration example of the recording data processing unit 43 shown in FIG. 1 will be described with reference to FIG. 2A. As shown in FIG. 2A, the recording data processing unit 43 shown in FIG. 1 includes a recording data input unit 431, a delay unit 432, a counter 433, and an output unit 434.

The recording data input unit 431 is, for example, a register, which takes in a signal (recording data) indicating the valve opening degree output by the LVDT voltage processing unit 42 at a high-speed cycle TH, holds the signal until the next taking-in timing, and outputs the signal.

The delay unit 432 outputs a plurality of output signals, each of which is a signal obtained by delaying the input signal (the input signal to the delay unit 432 (=the output of the recording data input unit 431)) by a plurality of different delay times. The delay unit 432 shown in FIG. 2A includes five delay circuits 4321 to 4325 (five stages) connected in series in multiple stages. Each of the delay circuits 4321 to 4325 delays the input signal by the same predetermined unit delay time TD and outputs the delayed signal. In the present embodiment, as an example, it is assumed that the unit delay time TD is 20 ms. The delay circuit 4321 receives the output signal of the recording data input unit 431 as an input signal, and delays the input signal by the unit delay time TD and outputs the delayed signal. The delay circuit 4322 receives the output signal of the delay circuit 4321 as an input signal, and delays the input signal by the unit delay time TD and outputs the delayed signal. The delay circuit 4323 receives the output signal of the delay circuit 4322 as an input signal, and delays the input signal by the unit delay time TD and outputs the delayed signal. The delay circuit 4324 receives the output signal of the delay circuit 4323 as an input signal, and delays the input signal by the unit delay time TD and outputs the delayed signal. The delay circuit 4325 receives the output signal of the delay circuit 4324 as an input signal, and delays the input signal by the unit delay time TD and outputs the delayed signal. The signal input to the delay circuit 4321 is delayed by a unit delay time TD, twice the unit delay time TD, three times the unit delay time TD, four times the unit delay time TD, and five times the unit delay time TD and output from the delay circuits 4322, 4323, 4324, and 4325. Each of the delay circuits 4321 to 4325 operates at a high-speed cycle TH. The output signals of the delay circuits 4321 to 4325 are updated every high-speed cycle TH. The data is taken in by the delay circuits 4321 to 4325 in the order of the delay circuits 4325 to 4321, with a predetermined time lag between each other. In the present embodiment, the output signals of the delay circuits 4321 to 4325 of the delay unit 432 become valid signals at a point in time when 100 ms has elapsed from the start of operation. In the present embodiment, the delay unit 432 has a configuration in which the delay circuits 4321 to 4325 that delay an input signal by a predetermined unit delay time TD and output the delayed signal are connected in series in multiple stages. The delay unit 432 need only have the same functionality as a configuration in which delay circuits that delay an input signal by a predetermined unit delay time TD and output the delayed signal are connected in series in multiple stages. For example, a plurality of delay circuits in which the time for delaying the signal is shifted by a unit delay time TD may be provided in parallel, and the output signal of the recording data input unit 431 may be input to each of the delay circuits as an input signal. Alternatively, the delay unit 432 may be configured using a plurality of storage areas, an arithmetic circuit that manages the data update operation of each storage area, and the like. FIG. 2B shows an example in which the delay unit 432 is configured by connecting in parallel a plurality of delay circuits 4321, 4322a, 4323a, 4324a, and 4325a having different delay times. In this case, by setting the delay times of the delay circuits 4321, 4322a, 4323a, 4324a, and 4325a to a unit delay time TD, twice the unit delay time TD, three times the unit delay time TD, four times the unit delay time TD, and five times the unit delay time TD, the delay unit 432 in FIG. 2A and each output signal can be made identical to each output signal of the delay unit 432 in FIG. 2B. In addition, although details will be described later, in the present embodiment, the number of stages of the delay circuits 4321 to 4325 shown in FIG. 2A is equal to or greater than the value obtained by adding 1 to the value obtained by dividing the low-speed cycle TL (the “time interval” in the present disclosure) by the unit delay time TD. A matter common to both the configurations of FIGS. 2A and 2B is that the longest delay time in the output signal of the delay unit 432 is equal to or greater than the value obtained by multiplying the shortest delay time by the value obtained by adding 1 to the value obtained by dividing the “time interval” by the shortest delay time in the output signal of the delay unit 432. In the following, an operation example and the like will be described with respect to the delay unit 432 shown in FIG. 2A.

As shown in FIG. 2A, the counter 433 is a counter that counts up by “4” at a high-speed cycle TH, and when it counts up to 9999, it returns to 0 and starts counting up again. The counter 433 includes a signal generation circuit 4331, a gate 4332, an addition circuit 4333, a signal generation circuit 4334, and a comparison circuit 4335, and the output signal of the addition circuit 4333 indicates a count value. The signal generation circuit 4331 outputs a signal indicating the constant “0”. The signal generation circuit 4334 outputs a signal indicating the constant “4”. The comparison circuit 4335 compares the count value with a constant “9999”, and resets the output of the gate 4332 to “0” in a case where the count value is equal to or greater than the constant “9999”. The addition circuit 4333 adds “4” to the output of the gate 4332, and outputs the result of the addition as a count value at the next high-speed cycle TH. In this case, the count value “4” corresponds to 4 ms (=high-speed cycle TH).

The output unit 434 is a buffer (or a buffer memory), and each piece of data stored in the output unit 434 is transmitted to the low-speed calculation control device 2 via the communication unit 3 at a communication cycle TC. The output unit 434 stores the output signal of the recording data input unit 431 (the input signal of the delay circuit 4321), the output signals of the delay circuits 4321 to 4325, and the count value as data DA11 to DA17 at a high-speed cycle TH, and holds them until the next storage timing. In the present embodiment, the output unit 434 outputs the input signal of the delay circuit 4321 and a plurality of output signals of the delay circuits 4321 to 4325 to the communication unit 3. Moreover, the output unit 434 further outputs count values corresponding to transmission times of the output signals of the plurality of delay circuits 4321 to 4325 that the output unit 434 outputs. However, the output unit 434 may be configured not to output the output signal of the recording data input unit 431 to the communication unit 3. In this case, for example, a delay circuit is added to the delay unit 432, which delays the output signal of the delay circuit 4325 by an additional unit delay time TD and outputs the delayed signal, and the output of this added delay circuit is output by the output unit 434 to the communication unit 3. In this case, as in a case where the output signal of the recording data input unit 431 is not output to the communication unit 3, the output unit 434 can output six pieces of data DA11 to DA16, each shifted by the unit delay time TD, to the communication unit 3. That is, the output unit 434 may pass delayed outputs of −20 ms, −40 ms, −60 ms, −80 ms, −100 ms, and −120 ms to the communication unit 3. That is, in the present embodiment, the delay unit 432 and the output unit 434 can be configured so that the delay unit 432 outputs a plurality of output signals, each of which is a signal obtained by delaying the input signal by a plurality of different delay times, and the output unit 434 outputs the input signal of the delay unit 432 and the plurality of output signals of the delay unit 432 to the communication unit 3.

On the other hand, the low-speed calculation control device 2 includes an input unit 23 as shown in FIG. 2A (not shown in FIG. 1). The input unit 23 is a buffer (or a buffer memory) that receives, at a low-speed cycle TL, the data DA11 to DA17 transmitted from the high-speed calculation module 4 at a communication cycle TC, and stores the data as data DA21 to DA27. In this case, the communication unit 3 transmits the data DA11 to DA17 at the communication cycle TC, but the input unit 23 does not receive the data DA11 to DA17 in synchronization with the communication cycle TC, but receives the data DA11 to DA17 most recently transmitted by the communication unit 3 at the low-speed cycle TL and stores the data as data DA21 to DA27. In this case, the data DA21 to DA27 are updated at a low-speed cycle TL. In the present embodiment, the input unit 23 is input a plurality of input signals or output signals of the plurality of delay circuits 4321 to 4325 output by the output unit 434 to the communication unit 3 at time intervals longer than the delay time TD, and stores the signals as data DA21 to DA27.

The storage device 22 also stores the plurality of input signals or output signals DA11 to DA16 and the count value DA17 of the plurality of delay circuits 4321 to 4325, which are stored in the input unit 23 as data DA21 to DA27, at the low-speed cycle TL. The storage of the recording data in the storage device 22 may be performed, for example, by constantly holding a certain period of the most recent data, or by using the generation (or input) of a predetermined signal as a trigger to execute the process continuously for a predetermined period of time, and then going into standby mode again after the predetermined period of time has elapsed. The storage device 22 is a configuration example of a “storage unit” according to the present disclosure.

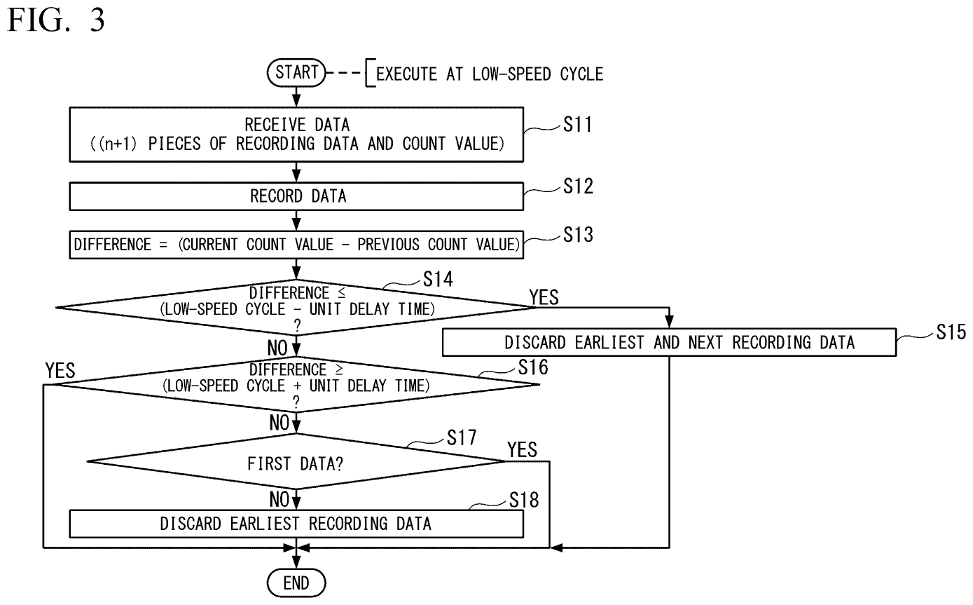

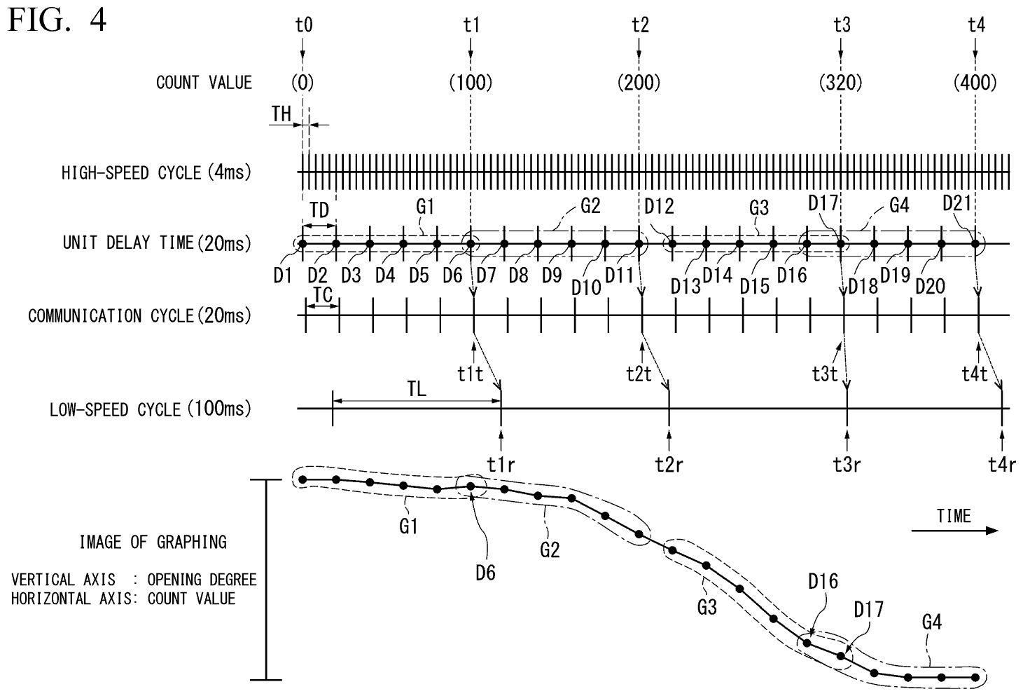

Next, an operation example of the control system 1 will be described with reference to FIGS. 3 and 4. FIG. 3 is a flowchart showing an operation example of the low-speed calculation control device 2 according to the embodiment of the present disclosure. FIG. 4 is a timing chart showing an operation example of the control system 1 according to the embodiment of the present disclosure. In the following operation example, a part of a plurality of pieces of recording data generated in the high-speed calculation module 4 at a high-speed cycle TH (4 ms) is transmitted from the high-speed calculation module 4 to the low-speed calculation control device 2 at a communication cycle TC (20 ms) in the communication unit 3, and the low-speed calculation control device 2 receives a part of the plurality of pieces of transmitted recording data as recording data D1 to D21 at a low-speed cycle TL (100 ms).

FIG. 4 shows, with the horizontal axis as time, a timing correspondence relationship between the count value, the high-speed cycle TH (4 ms), the unit delay time TD (20 ms), the communication cycle TC (20 ms), and the low-speed cycle TL (100 ms), and an image of the graphing of recording data by the calculation unit 21. In the recording data, the vertical axis corresponds to the valve opening degree, and the horizontal axis corresponds to time. Moreover, the delay unit 432 assumes that 100 ms or more has elapsed since the start of operation, and that the output signals of the delay circuits 4321 to 4325 are all valid.

Also, it is assumed that at time to, the count value is “0”. Moreover, at time t1, which is 100 ms (=25×TH) after time to, the count value is “100”. Moreover, at time t2, which is 200 ms (=50×TH) after time t0, the count value is “200”. Moreover, at time t3, which is 320 ms (=80×TH) after time t0, the count value is “320”. Moreover, at time t4, which is 400 ms (=100×TH) after time to, the count value is “400”.

Moreover, the values of data DA11 to DA16 at time t1 are recording data D6 to D1. In FIG. 4, the black circles correspond to the timing at which the recording data D1 to D21 are output from the LVDT voltage processing unit 42. The recording data D6 to D1 stored in the output unit 434 at time t1 are transmitted by the communication unit 3 at time t1t of the next communication cycle TC after time t1, and are input to the input unit 23 at time t1r of the next low-speed cycle TL after time t1t. At time t1r, the low-speed calculation control device 2 receives a data group G1 including the recording data D6 to D1 and the count value (100).

Moreover, the values of data DA11 to DA16 at time t2 are recording data D11 to D6. The recording data D11 to D6 stored in the output unit 434 at time t2 are transmitted by the communication unit 3 at time t2t of the next communication cycle TC after time t2, and are input to the input unit 23 at time t2r of the next low-speed cycle TL after time t2t. At time t2r, the low-speed calculation control device 2 receives a data group G2 including the recording data D11 to D6.

Moreover, the values of data DA11 to DA16 at time t3 are recording data D17 to D12. The recording data D17 to D12 stored in the output unit 434 at time t3 are transmitted by the communication unit 3 at time t3t of the next communication cycle TC after time t3, and are input to the input unit 23 at time t3r of the next low-speed cycle TL after time t3t. At time t3r, the low-speed calculation control device 2 receives a data group G3 including the recording data D17 to D12.

Moreover, the values of data DA11 to DA16 at time t4 are recording data D21 to D16. The recording data D21 to D16 stored in the output unit 434 at time t4 are transmitted by the communication unit 3 at time t4t of the next communication cycle TC after time t4, and are input to the input unit 23 at time t4r of the next low-speed cycle TL after time t4t. At time t4r, the low-speed calculation control device 2 receives a data group G4 including the recording data D21 to D16.

In the example shown in FIG. 4, the recording data D6 overlaps between the data group G1 and the data group G2. Therefore, for example, by discarding the recording data D6 in the data group G2, each piece of recording data contained in the data group G1 and each piece of recording data contained in the data group G2 can be configured as time-series data with the unit delay time TD as a sampling cycle without any overlap or loss.

In the example shown in FIG. 4, there is no overlap of recording data between the data group G2 and the data group G3. Therefore, for example, by discarding the recording data, each piece of recording data contained in the data group G2 and each piece of recording data contained in the data group G3 can be configured as time-series data with the unit delay time TD as a sampling cycle without any overlap or loss.

In the example shown in FIG. 4, two pieces of recording data D16 and D17 overlap in the data group G3 and the data group G4. Therefore, for example, by discarding the recording data D16 and D17 in the data group G4, each piece of recording data contained in the data group G3 and each piece of recording data contained in the data group G4 can be configured as time-series data with the unit delay time TD as a sampling cycle without any overlap or loss.

The recording data D1 to D21 may be reconstructed as time-series data within the low-speed calculation control device 2 or outside the low-speed calculation control device 2, for example. In a case where the reconstruction is performed within the low-speed calculation control device 2, it may be performed within the same or next low-speed cycle TL after times T1r to T4r.

FIG. 3 shows an operation example in a case where the calculation unit 21 in the low-speed calculation control device 2 performs reconstruction. The process shown in FIG. 3 is executed at a low-speed cycle TL. In the process shown in FIG. 3, first, the input unit 23 receives (n+1) pieces of recording data and a count value (step S11). Here, n is a value obtained by dividing the time interval of the input by the input unit 23 (the low-speed cycle TL in the present embodiment) by the unit delay time TD in the delay unit 432. In the present embodiment, the value obtained by dividing 100 ms by 20 ms is “5”. In this case, in step S11, the (5+1) pieces of recording data and the count value are input to the input unit 23.

Next, the storage device 22 stores the (n+1) pieces of recording data and the count value input to the input unit 23 (step S12). Next, the calculation unit 21 calculates a difference by subtracting the previous count value from the current count value (step S13).

Next, the calculation unit 21 determines whether or not the difference is equal to or less than (low-speed cycle TL-unit delay time TD) (step S14). In a case where the difference is equal to or less than (low-speed cycle TL-unit delay time TD) (step S14: YES), the calculation unit 21 discards the earliest and next recording data among the received (5+1) pieces of recording data (step S15) and ends the process shown in FIG. 3. In the example shown in FIG. 4, the count value received at time t4r is 400, and the previous count value is 320. In this case, the difference “80” is equal to 80 ms, which is the value obtained by subtracting the unit delay time TD=20 ms from the low-speed cycle TL=100 ms. Therefore, among the recording data D21 to D16 received at time t4r, the earliest recording data D16 and the next recording data D17 are discarded.

On the other hand, in a case where the difference is not equal to or less than (low-speed cycle TL-unit delay time TD) (step S14: NO), the calculation unit 21 determines whether or not the difference is equal to or greater than (low-speed cycle TL+unit delay time TD) (step S16). In a case where the difference is equal to or greater than (low-speed cycle TL+unit delay time TD) (step S16: YES), the calculation unit 21 does not discard the recording data and ends the process shown in FIG. 3. In the example shown in FIG. 4, the count value received at time t3r is 320, and the previous count value is 200. In this case, the difference “120” is equal to 120 ms, which is the value obtained by adding the unit delay time TD=20 ms to the low-speed cycle TL=100 ms. Therefore, none of the recording data D17 to D12 received at time t3r is discarded.

In a case where the difference is not equal to or greater than (low-speed cycle TL+unit delay time TD) (step S16: NO), the calculation unit 21 determines whether or not the recording data is the first data (step S17). In a case where the recording data is the first data (step S17: YES), the calculation unit 21 does not discard the recording data and ends the process shown in FIG. 3. In a case where the recording data is not the first data (step S17: NO), the calculation unit 21 discards the first recording data (step S18) and ends the process shown in FIG. 3. In the example shown in FIG. 4, when the recording data received at time t1r is the first recording data, none of the recording data D6 to D1 received at time t1r is discarded. Furthermore, in the example shown in FIG. 4, when the recording data received at time t2r is not the first recording data, among the recording data D11 to D6 received at time t2r, the earliest recording data D6 is discarded.

As described above, in the present embodiment, the control system 1 includes the low-speed calculation control device 2 (first control device), the high-speed calculation module 4 (second control device), and the communication unit 3 that inputs and outputs predetermined signals between the low-speed calculation control device 2 and the high-speed calculation module 4. The high-speed calculation module 4 includes the delay unit 432 that outputs a plurality of output signals, each of which is a signal obtained by delaying an input signal by a plurality of different delay times, and the output unit 434 that outputs the input signal and the plurality of output signals of the delay unit 432 to the communication unit 3. The low-speed calculation control device 2 also includes the input unit 23 that an input signal and a plurality of output signals of the delay unit 432 from the communication unit 3 is input to at a time interval (low-speed cycle TL) longer than the shortest delay time (unit delay time TD), and a storage unit (storage device 22) that stores the input signal and the plurality of output signals of the delay unit 432 that have been input. According to the present embodiment, a signal generated by the high-speed calculation module 4 (second control device) can be appropriately input from the communication unit 3 to the low-speed calculation control device 2 (first control device) at a cycle (high-speed cycle TH) shorter than the input cycle (low-speed cycle TL) from the communication unit 3 in the low-speed calculation control device 2 (first control device). In addition, it is desirable that the longest delay time (a delay time that is five times or six times the unit delay time TD) is equal to or greater than a value obtained by multiplying the shortest delay time (unit delay time TD) by the value obtained by adding 1 to the value obtained by dividing the time interval (low-speed cycle TL) by the shortest delay time (unit delay time TD).

In addition, in the present embodiment, the high-speed calculation module 4 includes, for example, the delay unit 432 in which the delay circuits 4321 to 4325 are connected in series in multiple stages, and which delay an input signal by a predetermined unit delay time TD and output the delayed signal, and the output unit 434 which outputs a plurality of input signals or output signals of the plurality of delay circuits 4321 to 4325 to the communication unit 3. The low-speed calculation control device 2 also includes the input unit 23 that a plurality of input signals or output signals from the communication unit 3 is input to at time intervals (low-speed cycle TL) longer than the unit delay time TD, and the storage device 22 that stores the plurality of input signals or output signals that have been input. Here, the time interval longer than the unit delay time TD means that the unit delay time TD is shorter than the time interval at which the input unit 23 is input to (that is, receives the recording data). In a case where the time interval for input to the input unit 23 is equal to the unit delay time TD, the number of pieces of recording data that can be received in that time interval will be the same between a case where the delay unit 432 is provided and a case where the delay unit 432 is not provided. On the other hand, in a case where the time interval for input to the input unit 23 is greater than the unit delay time TD, when the delay unit 432 is provided, the number of pieces of recording data that can be received in that time interval will remain the same or will increase. Therefore, according to the present embodiment, a signal generated by the high-speed calculation module 4 (second control device) can be appropriately input from the communication unit 3 to the low-speed calculation control device 2 (first control device) at a cycle shorter than the input cycle from the communication unit 3 in the low-speed calculation control device 2 (first control device).

In addition, in a case where the input unit 23 is input a plurality of input signals or output signals from the communication unit 3 at a time interval (low-speed cycle TL) longer than twice the unit delay time TD, when the delay unit 432 is provided, the number of pieces of recording data that can be received in that time interval will necessarily increase.

Furthermore, in a case where the number of stages of the delay circuits 4321 to 4325 is equal to or greater than a value obtained by adding 1 to the value obtained by dividing the time interval (low-speed cycle TL) at which the input unit 23 is input to (that is, receives the recording data) by the unit delay time TD, the recording data can be transmitted without loss.

Moreover, the output unit 434 further outputs count values corresponding to transmission times of the input signals and the output signals of the delay circuits 4321 to 4325 that the output unit 434 outputs. In this case, it is possible to determine whether or not duplicate recording data has been received based on the count value, and the recording data can be transmitted without loss even though the operations of the low-speed calculation control device 2 and the high-speed calculation module 4 are not synchronized.

Furthermore, in the present embodiment, among the input signals or output signals of the plurality of delay circuits 4321 to 4325 stored in the storage device 22 (storage unit), signals corresponding to the same count value are discarded.

### Operation and Effect

According to the control system and the control method of the above configuration, a signal generated by the high-speed calculation module 4 (second control device) can be appropriately input from the communication unit 3 to the low-speed calculation control device 2 (first control device) at a cycle shorter than the input cycle from the communication unit 3 in the low-speed calculation control device 2 (first control device).

### Other Embodiments

Although the embodiments of the present disclosure have been described in detail above with reference to the drawings, the specific configuration is not limited to the present embodiment, and design changes and the like that do not depart from the gist of the present disclosure are also included.

### Configuration of Computer

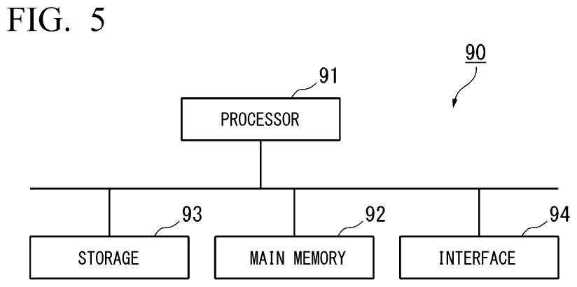

FIG. 5 is a schematic block diagram showing a configuration of a computer according to at least one embodiment.

A computer 90 includes a processor 91, a main memory 92, a storage 93, and an interface 94.

The above-mentioned low-speed calculation control device 2 and high-speed calculation module 4 are implemented in the computer 90. In addition, an operation of each of the above-described processing units is stored in the storage 93 in a form of a program. The processor 91 reads the program from the storage 93, loads the program into the main memory 92, and executes the above-mentioned processing in accordance with the program. In addition, the processor 91 secures a storage area corresponding to each storage unit described above in the main memory 92 in accordance with the program.

The program may be used for realizing some of functions of the computer 90. For example, the program may perform its function in combination with other programs already stored in storage, or in combination with other programs implemented in other devices. In other embodiments, the computer may include a custom large scale integrated circuit (LSI) such as a programmable logic device (PLD) in addition to or instead of the above-described configuration. Examples of the PLD include a programmable array logic (PAL), a generic array logic (GAL), a complex programmable logic device (CPLD), and a field programmable gate array (FPGA). In this case, some or all of the functions realized by the processor may be realized by the integrated circuit.

Examples of the storage 93 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 93 may be an internal medium directly connected to a bus of the computer 90, or may be an external medium connected to the computer 90 via the interface 94 or a communication line. In addition, in a case where the program is distributed to the computer 90 via the communication line, the computer 90 receiving the distribution may load the program into the main memory 92, and execute the processing described above. In at least one embodiment, the storage 93 is a non-transitory tangible storage medium.

### Supplementary Notes

For example, an embodiment of the present disclosure can be understood as follows.

(1) A control system according to a first aspect includes: a first control device; a second control device; and a communication unit configured to input and output a predetermined signal between the first control device and the second control device, in which the second control device includes: a delay unit configured to output a plurality of output signals, each of which is a signal obtained by delaying an input signal by a plurality of different delay times; and an output unit configured to output the plurality of output signals of the delay unit to the communication unit, and the first control device includes: an input unit configured to be input the plurality of output signals from the communication unit at a time interval longer than the shortest delay time; and a storage unit configured to store the plurality of input output signals. According to the present aspect and each of the following aspects, a signal generated by the high-speed calculation module 4 (second control device) can be appropriately input from the communication unit 3 to the low-speed calculation control device 2 (first control device) at a cycle shorter than the input cycle from the communication unit 3 in the low-speed calculation control device 2 (first control device).

(2) A control system according to a second aspect is the control system according to (1), in which the longest delay time is equal to or greater than a value obtained by multiplying the shortest delay time by a value obtained by adding 1 to a value obtained by dividing the time interval by the shortest delay time.

(3) A control system according to a third aspect is the control system according to (1) or (2), in which the output unit further outputs a count value corresponding to a transmission time of the output signal to be output.

(4) A control system according to a fourth aspect is the control system according to (1) to (3), in which, among the output signals stored in the storage unit, a signal corresponding to the same count value is discarded.

(5) A control device according to a fifth aspect is the first control device included in the control system according to (1) to (4).

(6) A control device according to a sixth aspect is the second control device included in the control system according to (1) to (4).

(7) A control method according to a seventh aspect is a control method for a control system including a first control device, a second control device, and a communication unit configured to input and output a predetermined signal between the first control device and the second control device, in which the second control device includes: a delay unit configured to output a plurality of output signals, each of which is a signal obtained by delaying an input signal by a plurality of different delay times; and an output unit configured to output the plurality of output signals of the delay unit to the communication unit, the control method including, in the first control device: a step of inputting the plurality of output signals from the communication unit at a time interval longer than the shortest delay time; and a step of storing the plurality of input output signals.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.
1: Control system
2: Low-speed calculation control device
3: Communication unit
4: High-speed calculation module
21: Calculation unit
22: Storage device
23: Input unit
432: Delay unit
434: Output unit
4321 to 4325: Delay circuit

1. A control system comprising:
a first control device;
a second control device; and
a communication unit configured to input and output a predetermined signal between the first control device and the second control device,
wherein the second control device includes:
a delay unit configured to output a plurality of output signals, each of which is a signal obtained by delaying an input signal by a plurality of different delay times; and
an output unit configured to output the plurality of output signals of the delay unit to the communication unit, and
the first control device includes:
an input unit configured to be input the plurality of output signals from the communication unit at a time interval longer than a shortest delay time; and
a storage unit configured to store the plurality of input output signals.

2. The control system according to claim 1,
wherein a longest delay time is equal to or greater than a value obtained by multiplying the shortest delay time by a value obtained by adding 1 to a value obtained by dividing the time interval by the shortest delay time.

3. The control system according to claim 2,
wherein the output unit further outputs a count value corresponding to a transmission time of the output signal to be output.

4. The control system according to claim 3,
wherein, among the output signals stored in the storage unit, a signal corresponding to the same count value is discarded.

5. A control device, which is the first control device included in the control system according to claim 1.

6. A control device, which is the second control device included in the control system according to claim 1.

7. A control method for a control system including a first control device, a second control device, and a communication unit configured to input and output a predetermined signal between the first control device and the second control device,
in which the second control device includes:
a delay unit configured to output a plurality of output signals, each of which is a signal obtained by delaying an input signal by a plurality of different delay times; and
an output unit configured to output the plurality of output signals of the delay unit to the communication unit,
the control method comprising, in the first control device:
a step of inputting the plurality of output signals from the communication unit at a time interval longer than a shortest delay time; and
a step of storing the plurality of input output signals.
